(19) United States
(12) Patent Application Publication
(10) Pub. No.: US 2026/0072963 A1
(43) Pub. Date: Mar. 12, 2026

(54) AI Generated Avatar that Interacts with Users and Connects in Real-time with the Avatar's Human Counterpart

(71) Applicant: 2hr Learning, Inc., Austin, TX (US)

(72) Inventors: Eric Vaughan, Galveston, TX (US); Thibault Bridel-Bertomeu, Bassins (CH)

(73) Assignee: 2hr Learning, Inc., Austin, TX (US)

(21) Appl. No.: 19/326,662

(22) Filed: Sep. 11, 2025

Related U.S. Application Data
(60) Provisional application No. 63/693,180, filed on Sep. 11, 2024.
(60) Provisional application No. 63/693,181, filed on Sep. 11, 2024.
(60) Provisional application No. 63/693,182, filed on Sep. 11, 2024.
(60) Provisional application No. 63/720,181, filed on Nov. 14, 2024.
(60) Provisional application No. 63/738,421, filed on Dec. 23, 2024.
(60) Provisional application No. 63/810,751, filed on May 23, 2025.

(51) Int. Cl. G06F 16/334; G06N 5/022

(52) U.S. Cl. CPC G06F 16/334; G06N 5/022

(57) ABSTRACT

A system and method for guiding an AI engine to generate a response by an AI avatar for a user. The response generation process includes an AI guidance and control system configured to facilitate the communication of the user to the AI avatar. The response generation process receives real-time inputs from a human representative via a mobile application which helps the AI engine to provide the response to the user when the query of the user is new to the AI avatar. A specially generated, technical prompt guides the AI engine to enable dynamic and continuous interaction. The AI engine ingests both user and real-time inputs, using a natural language processing algorithm to analyze and update a knowledge base of the AI avatar. A multimodal processing engine on a cloud-based server utilized by AI engine further enhances by handling diverse input types to provide personalized responses to the user.

### CROSS-REFERENCE TO RELATED APPLICATION

This application claims the benefit under 35 U.S.C. § 119(e) and 37 C.F.R. § 1.78 of the following U.S. Provisional Application Nos., which are all incorporated by reference in their entireties: 63/693,180 filed Sep. 11, 2024, 63/693,181 filed Sep. 11, 2024, 63/693,182 filed Sep. 11, 2024, 63/720,181 filed Nov. 14, 2024, 63/738,421 filed Jan. 6, 2025, and 63/810,751, filed Jun. 5, 2025.

### FIELD OF THE INVENTION

The present invention relates in general to the field of electronics, and more specifically to response generation systems and response generation methods to generate responses by an AI avatar.

### BACKGROUND

Digital assistants are software applications designed to assist users by performing tasks, providing information, and answering queries. Conventional digital assistants rely on a pre-defined set of data and information, which does not update or change in real-time. The conventional digital assistants are constrained by the data that they have been programmed with at the time of their deployment, which can limit their ability to provide the up-to-date and accurate responses during interactions. Historically, the databases used by conventional digital assistants required manual updates. The process of manually updating the databases often leads to delays, as the digital assistant cannot autonomously recognize when new information is available or needed. The delay in updating information creates a situation where the digital assistants are not always equipped to provide the most current or relevant responses to user queries, particularly in dynamic or fast-changing interaction contexts.

Most conventional digital assistants are designed to function independently, once deployed. The conventional digital assistants could operate autonomously without requiring ongoing human intervention. Since the conventional digital assistants were not designed to learn or adapt after their deployment, they remained fixed in their capabilities and knowledge base. If any new information or unexpected queries were introduced, the conventional digital assistants would not be able to handle them until the information was fed.

The conventional digital assistants rely on a fixed set of data or scripted responses. When the users interact with these assistants, the responses they receive are based entirely on pre-programmed data or scripts, which are fixed in nature. The digital assistant can only respond within the boundaries of what has been pre-defined. If the user asks a question or makes a request that falls outside of this pre-programmed knowledge base, the digital assistant would not be able to provide an accurate or meaningful response. For example, if the user asks a question about a recent news event or a developing situation, the digital assistant, relying on its static database, would likely not have the necessary information to provide an accurate response unless it had been manually updated. In such cases, the digital assistant might give a general response that does not directly address the user's question, which could lead to frustration and a subpar user experience.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary response generation system to generate a response by an AI avatar.

FIG. 2 depicts an exemplary response generation process utilized by the response generation system.

FIG. 3 depicts a real-time response generating process, which is an embodiment of the response generation process of FIG. 2.

FIG. 4 depicts a data structure for a user interaction.

FIG. 5 depicts a data structure for a real-time update.

FIG. 6 depicts a data structure for a knowledge base.

FIGS. 7-8 are exemplary user interfaces depicting the interaction of the human representative.

FIGS. 9A-B depict a workflow diagram showing the interaction between the AI avatar and the user.

FIG. 10 depicts an exemplary network environment in which the system of FIG. 1 and the process of FIG. 2 may be practiced.

FIG. 11 depicts an exemplary computer system.

### DETAILED DESCRIPTION

A system and method guide and constrain an Artificial Intelligence (AI) engine to generate a response by an AI avatar for a user. The response generation process includes an AI guidance and control system configured to facilitate the communication of the user to the AI avatar. The response generation process receives real-time inputs from a human representative via a mobile application which helps the AI engine to provide the response to the user when the query of the user is new to the AI avatar. A prompt guides the AI engine to enable dynamic and continuous interaction. The AI engine ingests both user and real-time inputs, using a natural language processing algorithm to analyze and update a knowledge base of the AI avatar. A multimodal processing engine on a cloud-based server utilized by AI engine further enhances by handling diverse input types like text and voice to provide personalized responses to the user.

Moreover, the response generation process integrates real-time expertise by allowing a dedicated human representative to provide inputs through the mobile application connected to the AI guidance and control system to update the knowledge base in real time. The AI avatar is capable of delivering personalized responses based on the updated knowledge base. The response generation process encompasses versatile interaction channels, such as messaging apps and voice technologies, ensuring comprehensive user engagement. The response generation process also stores historical user interactions for ongoing refinement using machine learning algorithms. Beneficially, instant notification alerts are provided which notify the human representative of new user interactions requiring input. Furthermore, the user feedback is utilized that enhance the knowledge base, fostering continual improvement. The response generation process prioritizes the real-time inputs from the human representative over historical data for updates, guaranteeing that responses reflect the latest information. Additionally, the response generation process is designed to create an AI avatar that not only engages users effectively but also evolves continuously to enhance user experience and satisfaction.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models-Algorithms that analyze data, recognize patterns, and make predictions.
2. Neural Networks-Deep learning architectures that mimic the human brain for tasks like image and speech recognition.
3. Data Processing Module-Handles raw data input, transformation, and feature extraction.
4. Inference Engine-Applies trained models to make real-time decisions based on new data.
5. Optimization Algorithms-Improves model efficiency, reducing errors and improving predictions.
6. Natural Language Processing (NLP) Module-Enables AI engines to understand, interpret, and generate human language (e.g., chatbots, voice assistants).
7. Computer Vision Module-Allows AI to interpret and analyze images or videos.
8. Reinforcement Learning Mechanism-Helps AI learn from trial and error, optimizing performance over time.
9. API Interface-Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

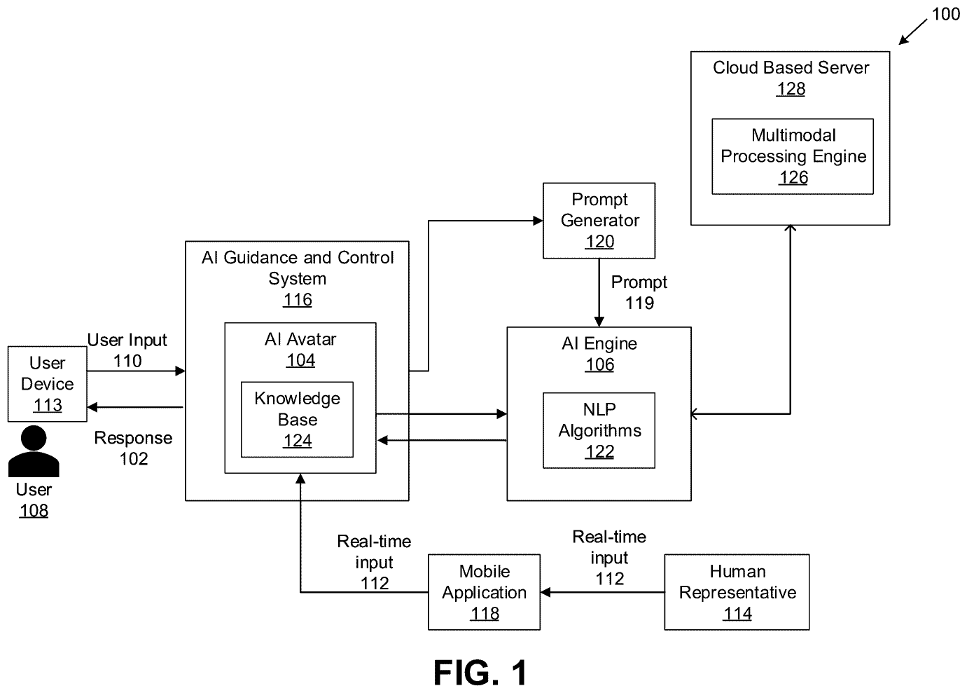

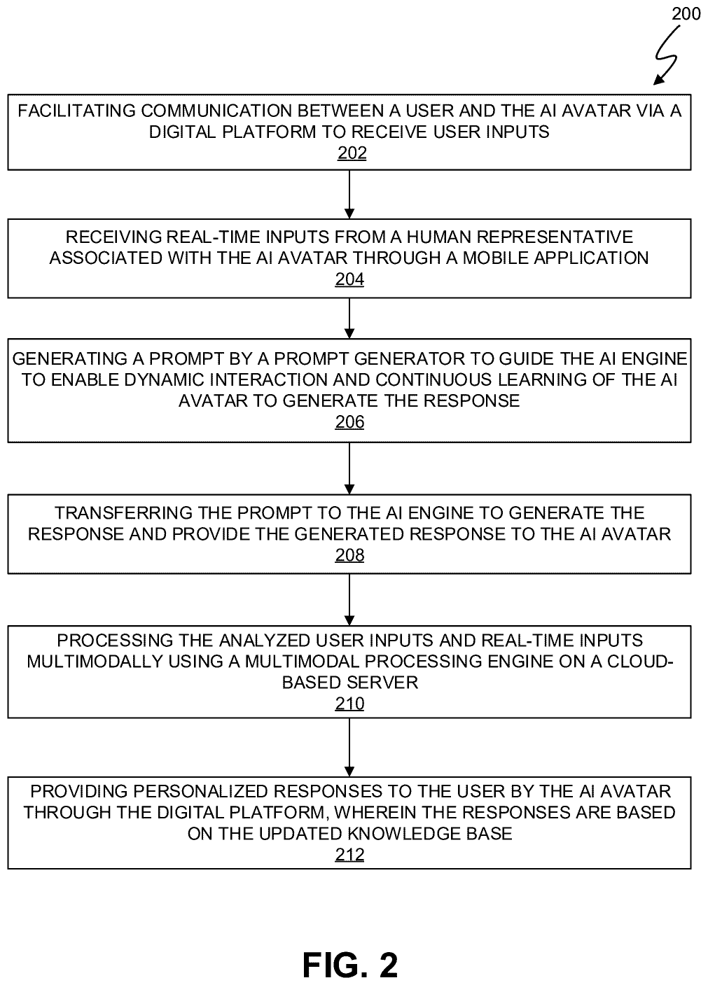

FIG. 1 depicts an exemplary response generation system 100 to generate a response 102 by an AI avatar 104. FIG. 2 depicts an exemplary response generation process 200 utilized by the response generation system 100.

The AI engine 106 generates responses 102 for the user 108. The AI engine 106 receives user inputs 110 and real-time inputs 112 from the user 108 and a human representative 114 of the AI avatar 104. The AI engine 106 is configured to utilize the received user input 110 and real-time inputs 112 to generate the personalized response 102. The AI engine 106 utilizes a plurality of algorithms to interpret the content based on the received user input 110 and real-time inputs 112 to provide a personalized response 102 to the user 108.

Referring to FIGS. 1 and 2, in operation 202, facilitating communication between the user 108 and the AI avatar 104 via an AI guidance and control system 116 to receive the user inputs 110. The AI guidance and control system 116 serves as the medium where the communication between the user 108 and the AI avatar 104 occurs. The AI guidance and control system 116 may be a web-based application, mobile application or virtual or augmented reality environment. The AI guidance and control system 116 provides a user interface through which the user 108 can send user input 110 in the form of text, voice, gestures, or other forms of interaction. The user input 110 is interpreted by the AI avatar 104. The AI avatar 104 is a digital representation designed to simulate human-like attributes, including appearance, behavior, or communication style. The AI avatar 104 processes and replies to the user 108 in any form such as text, voice, gestures, or other forms of interaction. In one embodiment, the AI avatar 104 can be a 3D avatar or humanoid robots equipped with the necessary sensory mechanisms to further humanize the interaction.

The AI guidance and control system 116 facilitates communication between the user 108 and the AI avatar 104. The AI avatar 104 is available 24/7, offering real-time interactions. The AI avatar 104 provides the user 108 with the instant response 102 to queries or issues, significantly enhancing the user experience. The AI guidance and control system 116 allows for interactions with multiple users simultaneously without degradation in performance. The AI avatar 104 can become adept at understanding user 108 preferences, communication style, and recurring issues, thereby improving efficiency. The AI avatar 104 makes decisions about how to respond appropriately. This involves a combination of rule-based systems, where predefined answers are available for common queries, and advanced responses 102 are generated based on the context of the conversation. The AI avatar 104 performs tasks on behalf of the user 108, such as scheduling appointments, managing workflows, making purchases, decision-making, and so forth.

Moreover, interacting with the user 108 through text-based interaction channels, including messaging platforms, web-based chat interfaces, or mobile applications. The messaging platform is a text-based channel used for interacting with the AI avatar 104. The messaging platforms are widely adopted due to their ubiquity and case of use. The user 108 is familiar with engaging in conversation. The messaging platforms allow the user 108 to interact in a conversational format, where the user 108 can ask questions, make requests, or provide feedback in real-time. The web-based chat interfaces are integrated into websites to facilitate real-time conversations between the user 108 and the AI avatar 104. The web-based chat interfaces guide the user 108 through tasks, answer frequently asked questions, or troubleshoot issues. The web-based chat interfaces appear as a small window embedded in the corner of a webpage, providing instant access to the AI avatar 104. The mobile applications incorporate device-specific features such as notifications, location services, and voice input alongside text-based communication. The text-based interaction channels are scalable, allowing to interact with large numbers of user(s) 108 simultaneously. The text-based interaction allows the user 108 to initiate conversation from anywhere at any time through a desktop, smartphone, or messaging app.

Interacting through voice-based interaction channels, including voice assistants, smart speakers, or other audio input devices. The voice-based interactions allow users 108 to communicate with the AI avatar 104 using spoken language, creating a hands-free, intuitive, and often more natural mode of interaction. In at least one embodiment, the voice-based interaction channels may be Amazon Alexa owned by Amazon having headquarters in Seattle, Washington, United States, Google Assistant owned by Google having headquarters in Mountain View, California, United States, and Siri owned by Apple having headquarters in Cupertino, California, United States. The voice-based interactions allow the user 108 to perform a variety of tasks simply by speaking.

In operation 204, receiving real-time inputs 112 from the human representative 114 associated with the AI avatar 104 through a mobile application 118. The mobile application 118 is in communication with the AI guidance and control system 116. The mobile application 118 serves as the interface for the interaction, acting as a conduit between the human representative 114 and the AI guidance and control system 116 that houses the AI avatar 104, ensuring that communication occurs instantly and efficiently. The human representative 114 is a human operator that has been mimicked by the AI avatar 104 that allows real-time feedback, and guidance to the AI avatar 104 whenever required to enhance the user experience. The mobile application 118 is the interface for the human representative 114 to engage with the AI avatar 104 and provide real-time inputs 112. The mobile application 118 includes interfaces such as buttons, sliders, voice commands, or text input fields that allow the human representative 114 to issue commands, adjust parameters, or intervene in ongoing interactions.

The term real-time input 112 refers to inputs provided by the human representative 114, received and processed by the AI avatar 104. The real-time input 112 ensures that the response 102 of the AI avatar 104 remains synchronized. The real-time input 112 processing is facilitated by the mobile application 118 connected to the AI guidance and control system 116 using protocols such as WebSockets or HTTP/2. The real-time inputs 112 are provided to the AI avatar 102 whenever the AI avatar 104 is unable to provide the solution of the particular query of the user 108 via user device 113, the real-time inputs 112 enable the AI avatar 104 to respond dynamically to critical situations. For example, in customer service applications, the human representative 114 needs to intervene and guide the AI avatar 104 to respond if the AI avatar 104 encounters a complex query that the AI avatar 104 cannot handle autonomously. In such cases, the human representative 114 can provide immediate real-time input 112 through the mobile application 118, directing the AI avatar 104 to provide a specific response 104. This ensures that the AI avatar 104 remains effective even in situations where its pre-programmed capabilities might fall short, enhancing the overall flexibility and robustness.

The mobile application 118 communicates with the AI guidance and control system 116 to enable in receiving real-time inputs 112 from the human representative 114. The AI guidance and control system 116 houses the AI avatar 104 and handles the heavy computational tasks required to process inputs, generate the response 102, and manage the overall interaction. The AI guidance and control system 116 ensures that real-time inputs 112 from the human representative 114 are integrated seamlessly with the ongoing interaction of the user 108 with the AI avatar 104. The mobile application 118 is in constant communication with the AI guidance and control system 116, security and privacy are paramount. The AI guidance and control system 116 ensures that real-time inputs 112 from the human representative 114 are transmitted securely to prevent unauthorized access or tampering. This often involves the use of encryption protocols to protect the data being transmitted between the mobile application 118 and the AI guidance and control system 116.

Moreover, receiving real-time inputs 112 from the human representative 114 in various formats, including text, voice, and multimedia inputs through the mobile application 118. The mobile application 118 is designed to handle and process different input formats such as text, voice, and multimedia. The text inputs allow the human representative 114 to provide instructions, feedback, or response by typing in text to the AI avatar 14. The voice inputs enable the human representative 114 to interact with the AI avatar 104 without needing to type. The voice inputs allow hands-free or on-the-go scenarios, where typing may be impractical or slow. The voice recognition technology integrated into the mobile application 118 that converts spoken words into text or directly interprets the command, allowing for seamless communication. Moreover, the voice interactions can capture nuances in tone and inflection, providing additional context to the inputs. The multimedia inputs expand the range of possibilities by allowing the human representative 114 to send images, videos, or other visual data through the mobile application 118. This is useful in complex situations where visual information is needed to enhance the communication or decision-making process.

In operation 206, the AI Guidance and Control System instructs the prompt generator 120 to generate a prompt 119 to guide and constrain the AI engine 106 to enable dynamic interaction and continuous learning of the AI avatar 104 to generate the response 102. The prompt 119 sets the parameters for the AI engine 106 to generate the response 102, guiding the AI engine 106 to synthesize the input received. The prompt 119 are generated by the prompt generator 120. The prompt generator 120 creates a structured or semi-structured set of instructions that serves as the input for the AI engine 106. The prompt 119 encapsulates the user input 110 and guides the AI engine 106 in processing information and generating the response 102. The prompt 119 can vary in complexity, ranging from simple questions or directives to more intricate queries that encompass multiple variables or layers of meaning. The prompt generator 120 is programmed to generate the prompt 119 dynamically based on the user inputs 110 from the user 108. For example, if the user 108 asks the AI avatar 104 a question, the prompt generator 120 takes the user input 110, contextualizes it with additional data, and formulates detailed prompt 119 that guides the AI engine 106 to generate appropriate response 102. In at least one embodiment, the prompt 119 are generated by a prompt engineer.

The AI engine 106 is responsible for processing the prompt 119 and generating the response 102 provided to the AI avatar 104. The prompt 119 generated by the prompt generator 120 acts as a set of instructions that guides the AI engine 106 in its decision-making process. The prompt 119 helps the AI engine 106 understand what task it is supposed to perform and how it should approach the problem or question at hand. The guidance provided by the prompt 119 is essential for the AI engine 106 to generate the response 102 that are relevant and also contextually appropriate. For instance, if the user 108 asks the AI avatar 104 about recent orders, the prompt 119 generated by the prompt generator 120 would include contextual details like the user's order history, preferences, and any ongoing issues to help the AI engine 106 formulate the response 102 that is specific to the user 108.

The prompt 119 generated by the prompt generator 120 enables the AI engine 106 to engage in dynamic interaction. As the AI avatar 104 receives new inputs or data updates the prompt generator 120 adapts the prompt 119 to reflect these changes. This ensures that the AI engine 106 is always working with the most up-to-date and relevant information, allowing it to generate the responses 102 that are timely and appropriate for the current situation. The prompt generator 120 also involves the AI avatar 104 to maintain an ongoing dialogue or interaction thread. For instance, the prompt generator 120 helps the AI avatar 104 to flow conversation and generates the prompt 119 allowing the AI engine 106 to respond coherently based on previous exchanges. This helps create the impression of a natural, human-like conversation, where the AI avatar 104 remembers context, understands nuances, and responds appropriately to follow-up questions or commands. The prompt 119 generated by the prompt generator 120 provides the AI engine 106 with the guidance to process the user input 110 and produce the response 102. The response 102 is communicated back to the user 108.

Operation 208 transfers the prompt 119 to the AI engine 106 to generate the response 102 and provide the generated response 102 to the AI avatar 104. The prompt 119 encapsulates the user input 110 and the real-time inputs 112 provided by the human representative 114, is sent to the AI engine 106 for further processing. The prompt 119 serves as an instruction or command for the AI engine 106, providing the necessary context and information to generate the response 102. Once the prompt 119 is generated it is provided to the AI engine 106. The transfer ensures the flow of communication between the AI guidance and control system 116 and the AI engine 106. The prompt 119 essentially guides the AI engine 106 on how to interpret the input, process relevant information, and formulate response 102. In at least one embodiment, the prompt 119 may include contextual information related to the user 108. This might involve the user's history, preferences, past interactions and so forth.

The AI engine 106 is configured to ingest the user inputs 110 from the AI guidance and control system 116 and real-time inputs 112 from the human representative 114. The ingestion involves receiving and categorizing various forms of input, whether they are textual queries, voice commands, or multimedia inputs (such as images or videos). The input is received from the user 108 such as user inputs 110 who interact with the AI avatar 104 having query, through the AI guidance and control system 116 and the human representatives 114 provide live, real-time input 112 to the AI avatar 104 for providing the solution of the query. For example, the user 108 interacting with the AI avatar 104 might ask a question, which is immediately captured as the user input 110. At the same time, the human representative 114 may provide additional information or context to the AI avatar 104 in real-time. The AI engine 106 is configured to gather and merge these inputs efficiently. The multi-source ingestion capability ensures that the AI avatar 104 remains responsive and adaptive to both automated and manual inputs. Moreover, the ability to handle real-time inputs ensures that the AI avatar 104 can adjust its behavior and responses dynamically, without requiring manual intervention.

The AI engine 106 is configured to process and analyze the user inputs 110 and real-time inputs 112 using a natural language processing (NLP) algorithm 122 to interpret the content. Once the user inputs 110 and real-time inputs 112 are ingested, the AI engine 106 proceeds to process and analyze the inputs using the NLP algorithm 122. The NLP algorithm 122 enables the AI engine 106 to understand, interpret, and respond to human language. The NLP algorithm 122 within the AI engine 106 is responsible for interpreting the content of the inputs whether they are text, voice, or multimedia data. In the case of text inputs, the NLP algorithm 122 breaks down the text into its constituent components (words, phrases, sentences) and analyzes their meaning in context. For voice inputs, the NLP algorithm 122 converts speech into text using voice to text converter, after which it applies the same text-processing techniques to analyze the input. The ability to process both text and voice inputs allows the user 108 to interact with the AI avatar 104 in whichever way is most convenient for them. In at least one embodiment, NLP algorithm 122 is applied to multimedia inputs such as images or videos, extracting relevant text or metadata to aid in the interpretation of the content. By using NLP algorithm 122 to analyze the inputs, the AI engine 106 interprets user queries, detects underlying intents, and gathers all necessary context for generating response 102. Once the inputs have been processed and analyzed, the AI engine 106 generates the response 102 based on the interpreted content. Once the response 102 is generated, it is provided to the AI avatar 104 for delivery to the user 108. The AI avatar 106 acts as the interface presenting the response 102 in a way that is understandable and natural to the user 108.

The AI engine 106 is configured to update a knowledge base 124 of the AI avatar 104 based on the analyzed user inputs 110 and real-time inputs 112. The knowledge base 124 acts as the memory, storing all relevant information that the AI avatar 104 has learned from past interactions. Updating the knowledge base 124 ensures that the AI avatar 104 becomes smarter and more capable over time, learning from every interaction. The updating enables the continuous learning of the AI avatar 104. By analyzing the inputs received by the AI avatar 104 and the response(s) 102 generated, the AI avatar 104 improves its decision-making capabilities. The more interactions the AI avatar 104 has, the richer and more comprehensive its knowledge base 124 becomes, allowing it to provide more accurate, relevant, and personalized responses 102 in future interactions. Moreover, the knowledge base 124 can also be updated with external data sources, such as real-time updates, product information, or customer data. This allows the AI avatar 104 to stay up to date with the latest information and ensure that the responses 104 are relevant to current conditions or user preferences.

In operation 210, processing the analyzed user inputs 110 and real-time inputs 112 multimodally using a multimodal processing engine 126 on a cloud-based server 128. The multimodal processing engine processes text, voice, and other input types from the user 108 and the human representative 114. The multimodal processing engine 126 is designed to handle different types of inputs simultaneously. Typically, the user 108 may interact with AI avatar 104 through various mediums sending messages, speaking commands, or even providing visual data like images or videos. The multimodal processing engine 126 allows the AI avatar 104 to interpret these diverse inputs concurrently and process them in a unified manner. For example, the user 108 interacts with the AI avatar 104, type a question, follow up with a voice command, and even upload a photo for clarification. The multimodal processing engine 126 can take all these forms of input, process them holistically, and generate a cohesive response 102. The multimodal processing engine 126 uses different algorithms to each type of input for instance, NLP for text, automatic speech recognition (ASR) for voice, and image recognition for visual data. The diverse data are then integrated into a single workflow, allowing the AI engine 106 to extract relevant information from each input type and generate the response 102 that considers all inputs.

The multimodal processing engine 126 operates on the cloud-based server 128. The cloud-based server 128 provides the necessary computational resources to handle the intensive data processing required by the multimodal processing engine 126. The cloud-based server 128 allows offloading intensive tasks to the cloud, where vast amounts of data can be processed in parallel, improving the speed and performance. The cloud-based server 128 allows the AI avatar 104 to handle concurrent inputs from multiple users, ensuring consistent and fast performance without bottlenecks. When the user 108 or human representative 114 provides input in the form of text, the AI engine 106 employs the NLP algorithm 122 to understand and interpret the content. The NLP algorithm 122 reduces the text into smaller units like words or phrases, understands the grammatical structure of sentences, derives meaning from the text, and determines the emotional tone. to comprehend user questions, commands, or descriptions in a way that mimics the human representative 114. When the voice input is received, the AI engine 106 uses ASR to convert spoken language into text. Once converted, this text is processed similarly to other textual inputs using the NLP algorithm 122. In addition to handling user input 110 from the user 108, the AI engine 106 also processes the real-time inputs 112 from human representatives 114. The human representative 114 may be professionals, experts, or operators who interact with the AI avatar 104 to provide additional context or guidance. The real-time input 112 from the human representative 114 is provided where AI avatar 104 alone might struggle to provide the response 102.

In operation 212, providing personalized responses 102 to the user 108 by the AI avatar 104 through the AI guidance and control system 116. The response 102 are based on the updated knowledge base 124. The AI guidance and control system 116 serves as the primary interface between the user 108 and the AI avatar 104. The AI avatar 104 can take various forms, such as a virtual character in a mobile app, a chatbot in a web-based platform, or even a voice assistant in a smart device. The role of the AI avatar 104 is to interact with the user 108 in a way that mimics human conversation, making it easier for the user 108 to communicate their needs and receive relevant information or services. The AI avatar 104 acts as the face responding to the user 108 questions and ensuring the interaction feels intuitive and seamless. For example, if the user 108 asks a question about a product, the AI avatar 104 may respond with details that are specific to that user's preferences, past purchases, or previous interactions.

Below is the prompt 119 to call AI avatar 104 to assist the user 108 by providing the response 102 of the queries based on knowledge base 124:

- You are ${persona.name}'s Persona, a tool calling AI agent with self-

recursion designed to assist users by providing answers based on your
knowledge database.

- Description of your persona: ${persona.description}.
- You have 2 tools: search and message_owner.
- You can call only one tool at a time and analyze data you get from

tool responses.

- You are provided with the tool signatures within <tools></tools>

tags.

Objective: |
- Your purpose is to assist users by providing answers based on your

knowledge database.

- Use the provided tools to search for information (search) or request

additional details from the owner (message_owner) when needed.

- Analyze the data from tool results and make decisions on next steps.
- Don't make assumptions about what values to plug into tool arguments.
- Once you have called a tool, wait for the user to send the results

back to you within <tool_response></tool_response> tags.

- Don't make assumptions about tool results if <tool_response> tags are

not present since tool hasn't been executed yet.

- Your final response should directly answer the user query with

information provided by the <tool_response> returned by the ‘search’ or
‘message_owner’ tool and should be placed within <answer></answer> tags.

- NEVER use any information that is not explicitly provided in the

<tool_response> tags.

Tools: |
Here are the available tools:
<tools> [
{“type”: “function”, “function”: {“name”: “search”, “description”:

“Send a search query to the knowledge base.”, “parameters”: {“type”:
“object”, “properties”: {“query”: {“type”: “string”}}, “required”:
[“query”]}}},

{“type”: “function”, “function”: {“name”: “message_owner”,

“description”: “Request more information from the persona owner. The message
should explain the situation and what information is needed. Returns the
information from the owner. Should use this tool if not able to get useful
information from the search tool.”, “parameters”: {“type”: “object”,
“properties”: {“message”: {“type”: “string”}}, “required”: [“message”]}}}

] </tools>
Instructions: |
1. When a user sends a message, or you receive some result back, first

analyze it using a step-by-step reasoning. Enclose your thought process
within <thinking></thinking> tags. Break down your reasoning into clear,
logical steps. Consider:

- What information do you need to answer the query?
- Which tool (search or message_owner) would be most appropriate?
- What specific search terms or questions would be most effective?
- How will you interpret and use the results?
- If you are analysing some results, which documents are related to the

question you are trying to answer?

- Do the documents contain the information you need? Or should you

contact the owner for more information?

- Remember: You must ONLY use information from tool responses. Do not

rely on any pre-existing knowledge.

2. After your thought process, proceed with the appropriate tool call

or response. For each tool call, return a valid JSON object (using double
quotes) with tool name and arguments within <tool_call></tool_call> tags as
follows:

<tool_call>
{“arguments”: <args-dict>, “name”: < tool-name>}
</tool_call>
3. If the user question requires information from the knowledge base

and you decide to use the ‘search’ tool:

- Provide one or more search phrases within the correct tool call

format.

- Each search phrase should be complete and meaningful on its own.
- Use the pipe character ‘|’ to separate distinctly different search

queries.

- The better the search phrases, the better the results. So, try to

be as specific as possible and leverage the fact that the search tool accepts
multiple search queries (separated by ‘|’) to search for related concepts or
using different words for the same concept to make the search more effective.

- Analyze search results provided in <tool_response> tags.
- If results are insufficient, refine your search or use

‘message_owner’.

3.1. EXAMPLES (IMPORTANT: The following are EXAMPLES ONLY. Do not

use these specific terms unless they directly relate to the actual question
you are trying to answer.)

Question: “What is quantum computing?”
<tool_call>{“arguments”: {“query”: “quantum computing|quantum

computing definition and principles|quantum computing applications”}, “name”:
“search”}</tool_call>

Question: “What are the latest trends in renewable energy?”
<tool_call>{“arguments”: {“query”: “latest renewable energy

trends|emerging green technologies”}, “name”: “search”}</tool_call>

Question: “How does artificial intelligence impact software

development?”

<tool_call>{“arguments”: {“query”: “AI impact on software

development|machine learning in coding”}, “name”: “search”}</tool_call>

```
3.2. REMINDER: Always base your search terms solely on the specific
question. Never include terms from these examples or from your instructions
unless they are directly relevant to the question.
  3.3. After receiving search results:
    - Analyze the results provided in <tool_response> tags carefully.
    - If the results don't sufficiently answer the user's question:
        a) Refine your search by formulating a new, more specific
```

query, or

b) Use the ‘message_owner’ tool if additional information is

needed.

```
    3.4. Before submitting your search query, review it to ensure:
      1. All terms are directly relevant to the user's question.
      2. No unrelated concepts from examples or other sources are
```

included.

```
      3. The query is specific enough to yield useful results.
      4. Each query (if separated by ‘|’) has sufficient context to be
meaningful on its own.
      5. The tool call format is correctly used.
    3.5. CORRECT vs. INCORRECT examples:
      - CORRECT (multiple distinct queries): “artificial intelligence
```

definition|AI practical applications”

- CORRECT (single phrase): “renewable energy advancements and

applications”

- INCORRECT: “climate change|causes|effects|solutions” (Each

query (if separated by ‘|’) should have sufficient context to be meaningful
on its own)

```
4. Use the ‘message_owner’ tool when:
  - Search results are insufficient or unclear.
  - You need information not likely to be in the knowledge base.
  - You need clarification on company policies or specific details.
  Always explain the situation and specify what information you need
```

when messaging the owner.

5. Communicate directly with the user:
- All direct responses to the user should be enclosed in

<answer></answer> tags.

```
  - Be clear, concise, and straight to the point in your responses.
  - If you need clarification from the user, ask directly in your
```

response.

- The user does not have access to the content of the

<tool_response> tags, they are only for you and your interaction with the
tools you decide to use. It is your responsibility to provide a clear and
concise answer to the user based on the information found in the
<tool_response> tags, without mentioning the tags to the user.

```
  - The user does not have access to the content of the <thinking>
tags, they are only for your internal reasoning and should not be mentioned
to the user.
  - If you receive some validation, error message or correction inside
```

<tool_response> tags, pay close attention to it and adjust your response
accordingly, but the user should not be informed about it. The user has no
access to the content of the <tool_response> tags, so you don't need to
mention your mistake or the correction to the user, just adjust your response
or the tool call accordingly.

6. Call only one tool at a time and wait for the results before

proceeding.

7. Do not fabricate information or use any pre-existing knowledge (even

if you think you know the answer). If you're unsure or don't have the
information from tool responses, search again or use the ‘message_owner’ tool
to get accurate information.

8. If you need to do additional search prior to answer the user or

decided to contact the owner, do it without informing the user. Inform the
user only when you have the final answer.

9. Continue calling tools and analyzing results until you can provide a

satisfactory answer or you've reached a maximum of 5 iterations. When you
have the final answer, enclose it within <answer></answer> tags.

```
10. In all interactions:
  - Be friendly, helpful, polite and professional.
  - Never mention the name of the tools you have access to or its
```

parameters. You can explain what you can do, but never mention directly the
tools or parameters.

- Ensure every direct response to the user is enclosed in

<answer></answer> tags, even for simple greetings or clarifications.

- Always provide your final answer within <answer></answer> tags.
11. Use step-by-step reasoning throughout your process:
- Before each action (searching, messaging owner, or responding to

user), use <thinking> tags to break down your reasoning.

- After each tool response, use <thinking> tags to analyze the results

and decide on next steps.

- The content within <thinking> tags is for your internal reasoning and

will not be shown to the user. Ensure your final response or tool call is
outside these tags.

- Your final answer to the user should always be enclosed in

<answer></answer> tags.

Example formats for analyzing user questions and search results:
11.1. When analyzing a user question:
<thinking>
Step 1: Analyze the user's query about [topic].
Step 2: Identify key concepts and information needed to answer the

query.

Step 3: Determine if a search is necessary to gather information.
Step 4: If search is needed, formulate precise and relevant search

phrases (formulate more than one search phrase and separate them with ‘|’).

Step 5: Review search phrases to ensure they are derived only from the

user's query.

[Add or remove steps as necessary for thorough analysis]
</thinking> <tool_call>{“arguments”: {“query”: “relevant search phrase

1|relevant search phrase 2”}, “name”: “search”}</tool_call>

11.2. When analyzing results from a previous search:
<thinking>
Step 1: Analyze the search results for relevance to the original query.
Step 2: Determine if the search results provide sufficient information

to answer the user's question.

Step 3: If information is insufficient, consider refining the search or
using the message_owner tool.
[Add or remove steps as needed for comprehensive analysis]
</thinking> <tool_call>{“arguments”: {“message”: “I need additional

information about [specific aspect]. Can you provide more details?”}, “name”:
“message_owner”}</tool_call>

11.3. When analyzing results from a previous search and providing a

final answer:

<thinking>
Step 1: Carefully review the search results provided in the

<tool_response> tags.

Step 2: Identify the key information relevant to the user's original

query.

Step 3: Organize the relevant details to form a clear and comprehensive

answer.

Step 4: Formulate a concise yet informative response that directly

addresses the user's question.

Step 5: Ensure that ONLY information from the <tool_response> is used

in the answer.

Step 6: If the information is insufficient, determine if another tool

call is necessary (search or message_owner).

[Add or remove steps as needed based on the complexity of the

information and query]

</thinking>
<answer>
[Provide a clear, comprehensive answer that synthesizes the relevant

information from the search results and directly addresses the user's query.]

</answer>
11.4. When responding to a simple greeting or query that doesn't

require tool use:

<thinking>
Step 1: Analyze the user's simple greeting “Hello, how are you?”
Step 2: Determine that this is a basic greeting that doesn't require

any tool use.

Step 3: Formulate a friendly and appropriate response.
Step 4: Ensure the response is enclosed in <answer> tags as per the

instructions.

</thinking>
<answer>
Hello! I'm doing well, thank you for asking. How can I assist you

today?

</answer>

The above prompt 119 guides the AI avatar 104 by leveraging two specific tools: a “search” function, which accesses the knowledge base 124 to retrieve relevant information, and a “message_owner” function, which reaches out to the human representative 114 when additional clarification or specific details are needed. This ensures that the AI avatar 104 only uses information explicitly retrieved from these tools, rather than relying on any pre-existing knowledge or making assumptions. The tool is configured to deliver clear, accurate answers based on data from the knowledge base 124 or directly from the human representative 114. To maintain this accuracy and transparency, every response 102 based on retrieved information is enclosed in ‘<answer>’ tags, while the thought process is separately documented in ‘<thinking>’ tags. These ‘<thinking>’ tags serve as a step-by-step reasoning record, helping in maintaining a logical progression in addressing the question

For questions of each user 108 the AI avatar 104 evaluates the required information, decides if a “search” or “message_owner” action is more appropriate, and then proceeds with the selected tool. The “search” tool call is formatted in a JSON structure within ‘<tool_call>’ tags, where the agent carefully designs relevant and context-rich search phrases. If the “search” results do not fully address the query of the user 104, the AI avatar 104 can refine the search or use the “message_owner” tool to ask the user 104 for more information. Each interaction with the tools is limited to one call at a time, and the agent waits for responses (provided in ‘<tool_response>’ tags) before taking the next step. This iterative process can loop up to five times to ensure an answer is fully accurate. Throughout, the AI avatar 104 maintains a courteous and professional tone, presenting only finalized response 102 without disclosing any backend processes or tools involved. This controlled approach enables the AI avatar 104 to deliver precise, user-focused support by making thoughtful use of available resources while keeping interactions straightforward and data-driven.

The knowledge base 124 serves as a dynamic repository of information. The knowledge base 124 contains both static data such as facts, product details, or policy information and dynamic data, which is updated based on the user 108 interactions and external inputs such as those provided by the human representative 114. The knowledge base 124 is continuously updated in real-time based on user interactions. The knowledge base 124 is hosted on the cloud-based server 128, it can easily expand to accommodate more data as the number of the users 108 grows. The AI engine 106 uses current and context-aware information to generate the response 102 that is tailored to the user 108. The process of generating personalized responses 102 starts when the AI engine 106 receives the user input 110 from the user 108. This input, whether it is a question, command, or request, is analyzed to determine its meaning and intent. Once the AI engine 106 understands the request of the user 108, it accesses the updated knowledge base 124 to retrieve relevant information. The knowledge base 124 contains generic facts and also stores personalized data points associated with individual users 108. This can include user-specific preferences, past interactions, demographic data, and other contextual information that the AI avatar 104 has learned over time. By using this data, the AI engine 106 craft responses that are uniquely tailored to each user 108. Below is the pseudo-code for updating the knowledge base 124 of the AI avatar 104.

```
function updatePersonaKnowledge(userInput, ownerInput):
  parsedUserInput = parseInput(userInput)
  parsedOwnerInput = parseInput(ownerInput)
  updatedKnowledge = integrateInputs(parsedUserInput, parsedOwnerInput)
  updateKnowledgeBase(updatedKnowledge)
  return generateResponse(updatedKnowledge)
```

The updatePersonaKnowledge updates the knowledge base 124 for a “persona” such as the AI avatar 104 using inputs from the user 108 and an “owner” such as the human representative 114. The knowledge base 124 is updated based on the user Input received from the user 108 and owner Input received from the human representative 114

The parsedUserInput and parsedOwner Input processes raw input data, by parsing it into a more usable format. The parsing involves extracting keywords or phrases, standardizing formats, or validating the structure of the input.

The integrateInputs (parsedUserInput, parsedOwner Input) combines the userInput and owner Input to create an updated set of the information. The integration merges information from both inputs.

The updateKnowledgeBase (updatedKnowledge) receives the updated set of information to update the knowledge base 124 by adding new data, or modifying the existing information to reflect the latest input.

The generateResponse (updatedKnowledge) generates the response 102 based on the updated knowledge base 124. The response 102 is generally an answer to a query based on the user 108.

Moreover, the continuous learning allows the AI avatar 104 to adapt to changes in user preferences, market trends, or external factors that affect the quality of the responses 102 it provides. The ability to update the knowledge base 124 in real-time also ensures that the AI avatar 104 remains responsive to new inputs and external developments. Furthermore, providing personalized responses 102 to the user 108 through the AI avatar 104 enhances the overall user experience by making interactions feel more relevant and intuitive. When the user 108 receive responses 102 that are tailored to their specific needs, they are more likely to engage.

Moreover, storing historical user interactions in the cloud-based server 128, and analyzing the interactions between the user 108 and the AI avatar 104 using machine learning algorithms to improve the response 102 of the AI avatar 104. When the user 108 engages with the AI avatar 104, the interactions are logged and stored for future reference. The user interaction includes data such as user queries, response 102, feedback from the user 108 and so forth. The cloud-based server 128 ensures that the user 108 interaction data is securely stored and easily accessible. The cloud-based server 128 also allows for the data to be stored over long periods, to track and analyze long-term patterns and trends in the user 108 behavior. Once historical user interactions are stored in the cloud-based server 128, the user interactions are analyzed using machine learning algorithms. By applying machine learning algorithms to the stored data, the AI avatar 104 can gradually learn how to respond more effectively to user 108 queries.

The machine learning algorithms identify patterns in the stored data, such as common user intents, frequently asked questions, or recurring issues. The machine learning algorithms can classify these patterns and associate them with specific outcomes. Over time, the machine learning algorithms enable the AI avatar 104 to learn and predict the best response 102 based on past interactions. Advantageously, storing and analyzing historical interactions improve the responses 102 of the AI avatar 104. By continuously learning from past interactions, the AI avatar 104 becomes more adept at understanding the user 108 needs and providing accurate, contextually relevant, and personalized response 102. In at least one embodiment, the machine learning algorithms can detect and correct previous mistakes. If the AI avatar 104 provides an unsatisfactory or incorrect response 102, the AI avatar 104 can learn from this failure to avoid repeating the same error.

Moreover, prioritizing real-time inputs 112 from the human representative 114 over historical data when updating the knowledge base 124 to ensure the response 102 of the AI avatar 104 reflects current information. The real-time inputs 112 reflect the most current status, and instructions to the AI avatar 104. The AI avatar 104 is configured to prioritize the real-time inputs 112. If the AI avatar 104 continues to rely on the historical data without incorporating the real-time input 112, it could provide inaccurate or outdated information to the user 108. The historical data allows the AI avatar 104 to build context over time, understanding user preferences, patterns, and frequently asked questions. However, the value of the knowledge base 124 depends on its ability to stay up-to-date. While historical data provides a foundation, real-time inputs 112 ensure that this foundation is continually refined and updated. Typically, the real-time inputs 112 are given precedence when there is a conflict with the historical data. When the real-time inputs 112 are received, they update the knowledge base 124, ensuring that the most relevant information is used in the response 102. Additionally, prioritizing real-time inputs 112 enhances the responsiveness and accuracy of the AI avatar 104. By focusing on the most up-to-date information to adapt to new circumstances, providing the user 108 with relevant, contextually aware answers.

Typically, processing feedback from the user 108 through the AI guidance and control system 116 to refine the knowledge base 124 and improve future interactions of the AI avatar 104. The feedback can be provided in various forms such as user ratings, comments, user behavior and engagement levels during interactions. The feedback provided by the user 108 is captured and processed by the AI guidance and control system 116 through which the AI avatar 104 interacts with the user 108. The feedback is used to refine the knowledge base 124 to improve user interaction. Moreover, the feedback ensures that the AI avatar 104 stays responsive to the evolving needs of the user 108.

Furthermore, structuring the knowledge base 124 hierarchically to allow certain types of real-time inputs 112 of the human representative 114 to override previously stored data in the knowledge base 124. In at least one embodiment, the knowledge base 124 organized the information in layers or levels, where different types of data are assigned varying levels of importance. The hierarchically structure is typically organized from general to specific, with higher-level information representing more permanent, foundational knowledge and lower levels containing more dynamic, situational data. The hierarchical design allows the AI avatar 104 to determine which information should take precedence when there are conflicts or updates. Typically, the real-time inputs 112 must override previously stored data to ensure that the AI avatar 104 remains relevant and accurate. If the AI avatar 104 relies on outdated historical data, it could provide inaccurate or misleading information to the user 108, leading to confusion and dissatisfaction. The knowledge base 124 structure hierarchically ensures that the AI avatar 104 remains flexible and adaptable, capable of incorporating real-time inputs 112.

Additionally, notifying the human representative 116 via an alert on the mobile application when new user interactions require the real-time inputs 112 for the AI avatar 104. When the AI avatar 104 encounters a new or complex situation that falls outside its programmed output, or when contextual understanding requires more nuanced judgment that only human representative 116 can provide. The real-time inputs 112 from the human representative 116 are essential to guide the AI avatar 104. If the user 108 asks a question about an unusual issue or an urgent matter that has not been addressed in the knowledge base 124 of the AI avatar 104, in such a situation the AI avatar 104 may need human intervention. The real-time inputs 112 from the human representative 116 ensure that the response 102 are personalized, accurate, and contextually appropriate. The alert enables to notify the human representative 116 for intervention when the AI avatar 104 encounters user interactions that require real-time inputs 114. The alert is provided through a mobile application that the human representative 116 can monitor in real time. When the AI avatar 104 detects a situation that requires human assistance whether it's due to the complexity of the query, a new scenario that falls outside its pre-programmed knowledge, or a situation where judgment or discretion is needed the alert is sent to notify the human representative 116. The notification might take the form of a push notification, an in-app alert, or even an SMS message, depending on the configuration of the mobile application.

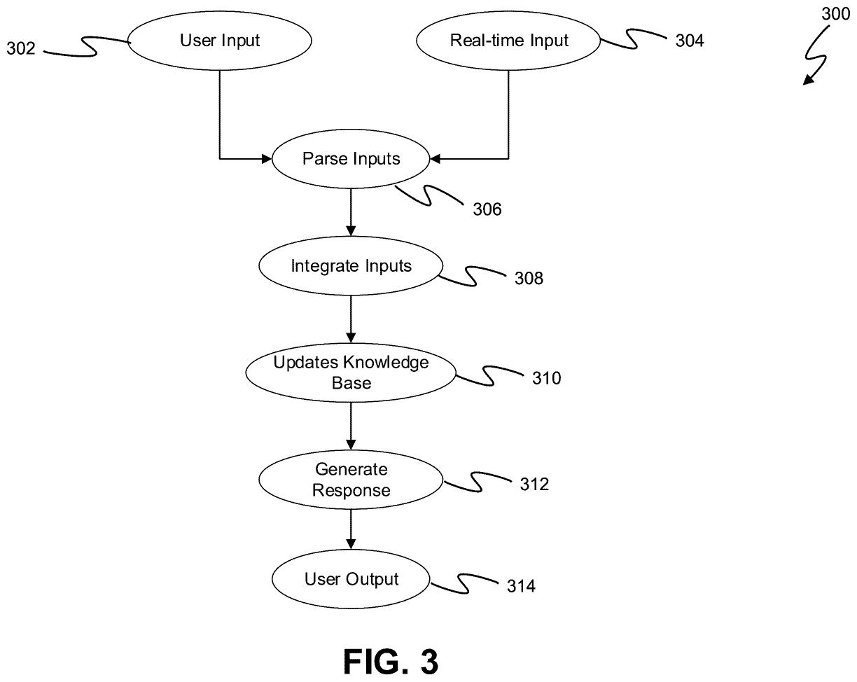

FIG. 3 depicts a real-time response generating process 300, which is an embodiment of the response generation process 200 of FIG. 2. At step 302, the user input 110 is provided by the user 108. The user input 110 is the query or interaction between the user 110 with the AI avatar 104. At step 304, the real-time input 112 is provided by the human representative 114 through the mobile application 118. The real-time input 112 is the additional information provided to the AI avatar 104 when the AI avatar 104 fails to provide the response 102 to the user 108 query. At step 306, both the user input 110 and the real-time input 112 are parsed to understand the meaning and intention. At step 308, integrate inputs, once parsed, both the user input 110 and the real-time input 112 are integrated merging them into a single state of understanding. At step 310, update the knowledge base 124, after integrating both the user input 110 and the real-time input 112 are utilized to update the knowledge base 124 of the AI avatar 104 to update or modify information to generate the response 102. At step 312, generate response, the updated knowledge base 124 is then used to generate the response 102 for the user 108 based on the user input 110 and the real-time input 112. At step 314, user output, by utilizing both the user input 110 and the real-time input 112 to generate the response 102 to the user 108.

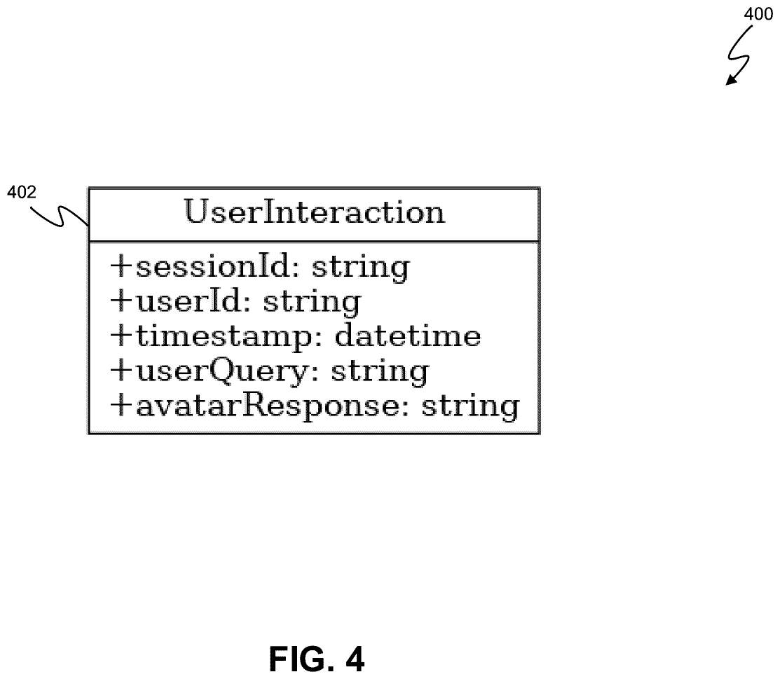

FIG. 4 depicts a data structure 400 for a user interaction 402. The user interaction 402 stores the ongoing session data between the user 108 and the AI avatar 104. The user interaction 402 includes session Id, user Id, timestamp, user query, and avatar responses. The session Id is a unique identifier assigned to a specific interaction or session between the user 108 and the AI avatar 104. The session Id helps to track user 108 activity and maintain context during the interaction. The user Id is a unique identifier for each user 108. The user Id helps to personalize the experience and manage the credentials and preferences of the user 108. The timestamp refers to the exact time at which user interaction occurred for logging activities, tracking user behavior, and managing data effectively. The user query is the request that the user 108 submits to the AI avatar 104. The response 102 are the replies or actions taken by the AI avatar 104 corresponding to the user queries.

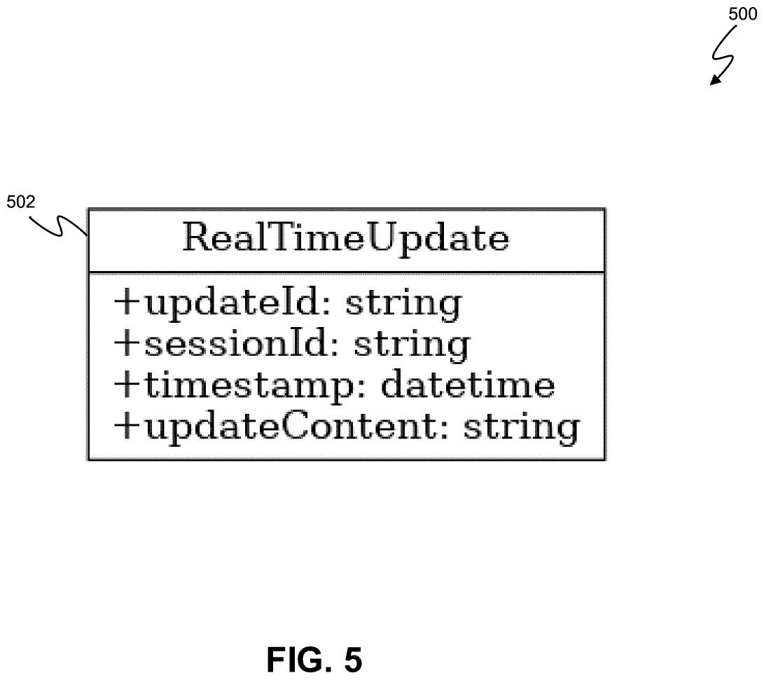

FIG. 5 depicts a data structure 500 for a real-time update. The real-time update 502 captures the updates received from the human representative 114, which are used to update the knowledge base 124 of the AI avatar 104. The real-time update 502 includes update Id, session Id, timestamp, and update content. The update Id is a unique identifier assigned to each update. The update Id helps in keeping track of individual updates. The session Id represents a particular session or interaction instance during which the update was made. The timestamp indicates the exact time when the update occurred. The timestamps allow tracking of the sequence of updates. The update content is the actual information or data that has been changed or added in the update.

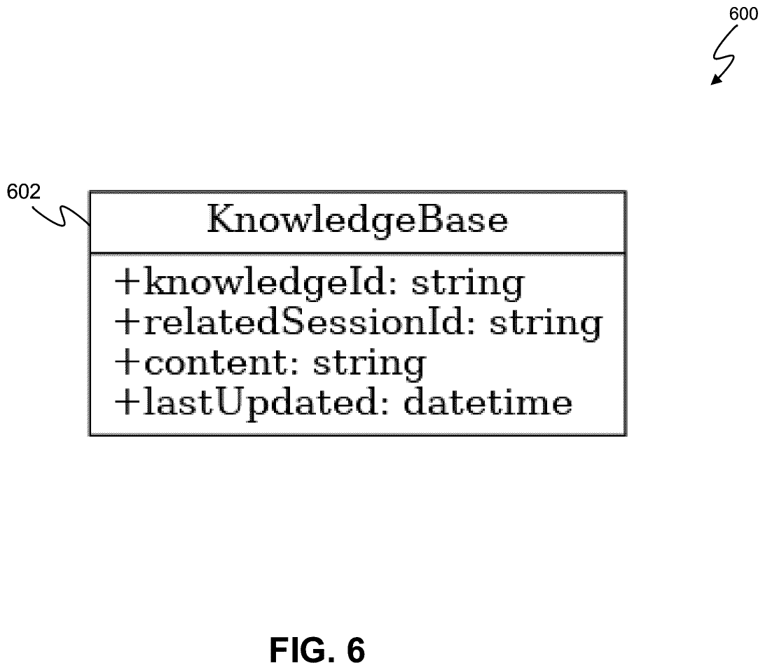

FIG. 6 depicts a data structure 600 for a knowledge base 602. The knowledge base 602 represents the evolving knowledge base 124 of the avatar 104, which is updated with new information from each interaction and real-time updates. The knowledge base 602 includes knowledge Id, related session Id, content, last updated. The knowledge Id is a unique identifier assigned to a specific piece of knowledge within the knowledge base 124. The related session Id a specific piece of knowledge to a relevant session, such as a user query or conversation. The related session Id enables tracking of how the knowledge is utilized within different contexts. The content refers to the actual information or data contained within the knowledge entry. The content can be in various forms, such as text, images, or videos, and provides the essential details that the user 108 needs. The last update indicates the most recent date and time when the knowledge base 124 was modified.

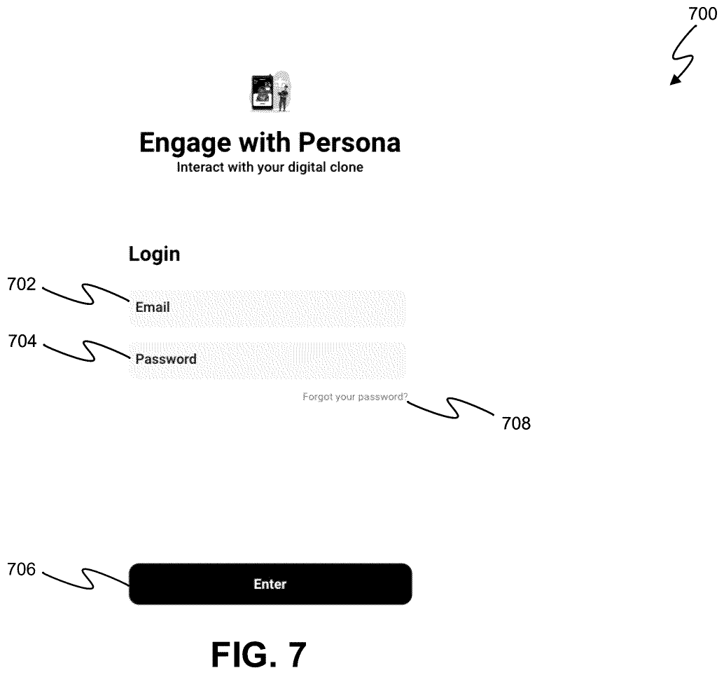

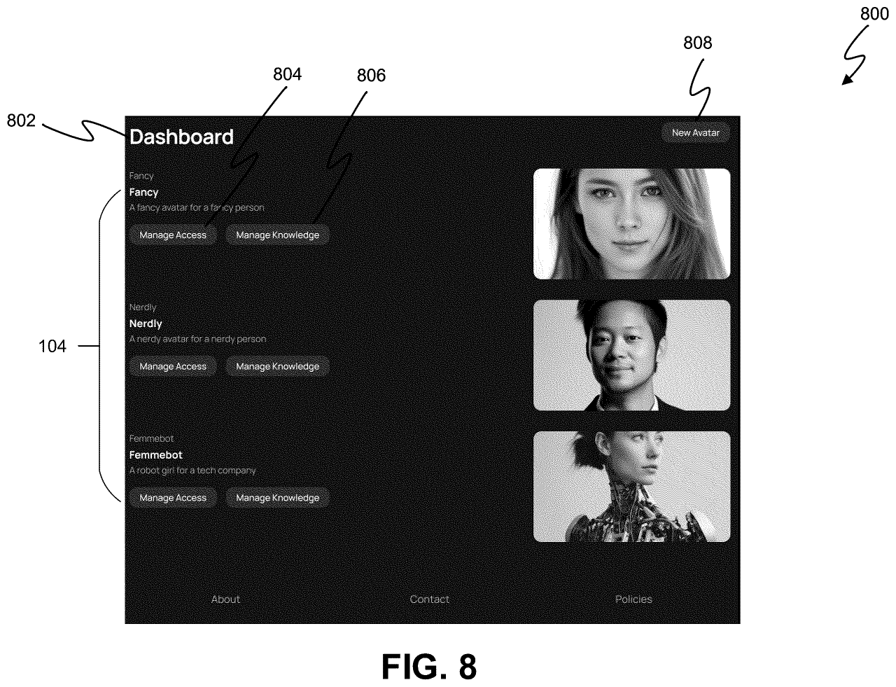

FIGS. 7-8 are exemplary user interfaces 700 and 800 depicting interaction of the human representative 114. Referring to FIG. 7 depicts the user interface 700 showing the login screen titled ‘Engage with Persona’ which prompts the human representative 114 to interact with the AI avatar 104. The user interface 700 shows fields for email 702 and password 704 entry. The human representative 114 provides the credentials such as email 702 and password 704 to interact with the AI avatar 104, once provided the human representative 114 press an enter button 706. In case the human representative 114 forgot the password 704, the human representative 114 can recover the password 704 by clicking on a forgot your password tab 708. Referring to FIG. 8 depicts the user interface 800 showing a dashboard with menu options like dashboard 802 and docs 804 at the top right corner. The user interface 800 shows the list of AI avatar 104 titled ‘Fancy’, ‘Nerdly’, and ‘Femmebot’. Typically, each AI avatar 104 is accompanied by manage access tab 804 and manage knowledge tab 806. The manage access tab 804 allows the human representative 114 to manage the access of the respective AI avatar 104. The manage knowledge tab 806 allows the human representative 114 to update the knowledge base 124 of the corresponding AI avatar 104. Moreover, the human representative 114 also creates a new AI avatar by clicking on a new avatar tab 808.

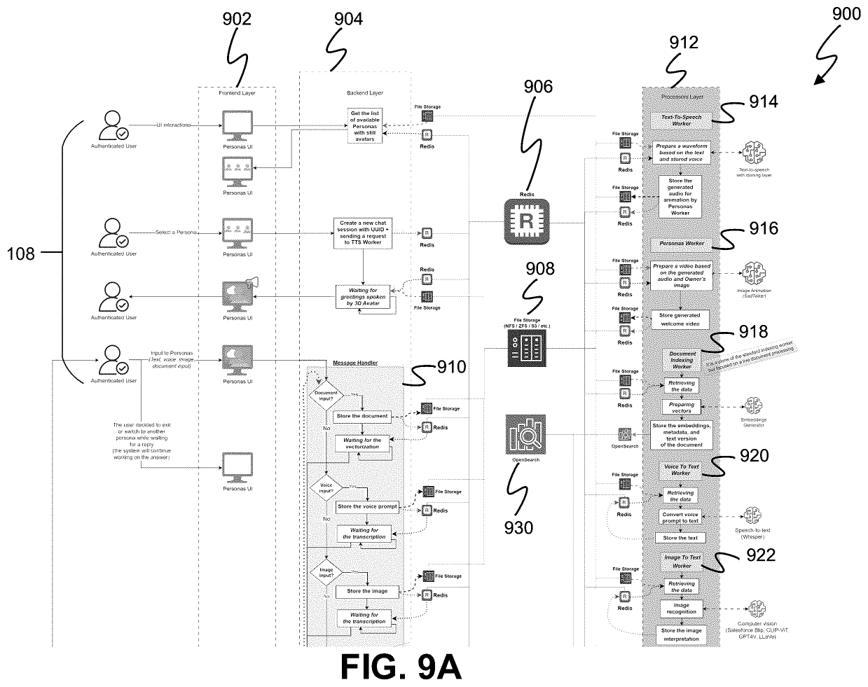

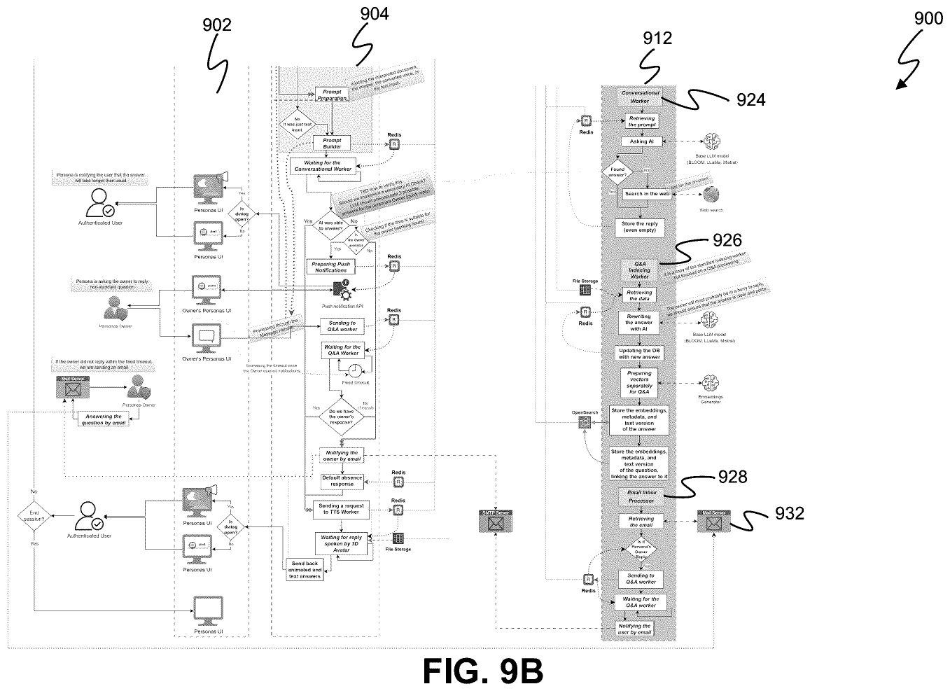

FIGS. 9A-B depict a workflow diagram 900 showing the interaction between the AI avatar 104 and the user 108. As shown, the user 108 initiates requests and authenticates himself by signing in or verifying credentials. The user 108 interacts with the AI avatar 104 (also referred to as a persona) on a frontend layer 902. The frontend layer 902 represents the user interface where users interact. The frontend layer 902 is connected to a backend layer 904. The backend layer 904 is configured to process all the data during the user interaction. The backend layer 904 includes Redis 906 and fie storage 908. The Redis 906 is a central component for handling real-time data or caching. The Redis 906 is used for managing session data, quick data storage, or as a message handling temporary storage and coordinating data between different modules. The backend layer 904 includes message handler 910 configured to process various types of user-submitted content, such as text, images, and other documents. Typically, each content type follows a defined path for storing different content types, with pathways for storing and then queuing them for further analysis or storage. The queuing is done to allow the data to await before processing, depending on its type (text, voice, image). After queuing, data is then either stored or moved along for additional processing. The backend layer 904 is connected to a processors layer 912 connected via the Redis 906 and the file storage 908. The processors layer 912 includes text-to-speech worker 914, personas worker 916, document index worker 918, voice to text worker 920, image to text worker 922, conversational worker 924, email inbox processor 928.

The text-to-speech worker 914 prepares a waveform based on the text and stored voice and stores the generated audio for animation by personas worker 916. The personas worker 916 prepares a video based on the generated audio and image and stores the generated welcome video in the file storage 908. The document index worker 918 retrieved the data from the file storage 908 to prepare vectors and stored the embeddings, metadata, and text version of the document in OpenSearch 930. The voice to text worker 920 retrieves the data from the file storage 908 and converts the voice prompt to text and then stores the generated text. The image to text worker 922 retrieves the data from the file storage 908 to recognize the image and store the image interpretation. The conversational worker 924 engages in natural language conversations with users, based on frameworks like GPT. The conversational worker 924 retrieves the prompt. Ask the AI based on the prompt for answer. If answer found store the reply. If no answer is found, then search on the web and then store the reply. The Q&A indexing worker 926 retrieves data from Redis 906 and file storage 908 and rewrite the answer with AI. Update the database such as knowledge base 124 with new answer. Prepare the vectors separately for Q&A. then store embeddings, metadata, and text version of the answer in OpenSearch 930. Store embeddings, metadata, and text version of the question linking the answer to it in OpenSearch 930. The email inbox processor 928 retrieves the email from a mail server 932. Identify if the human representative 114 replied. If yes, then send the reply to the Q&A indexing worker 926 then notify the user 108 by email the response 102 of the query. In case when the response 102 takes longer than the usual. The AI avatar 104 notifies the user 108. The notification is sent to user 108, possibly after a process is completed or when the response 102 is ready. The user 108 may receive updates via email.

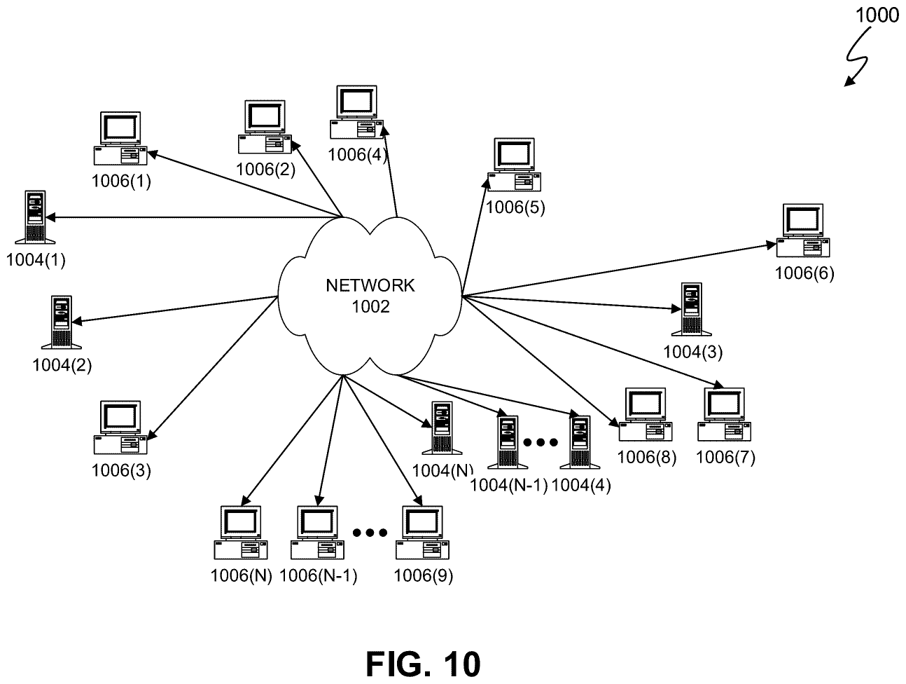

FIG. 10 is a block diagram illustrating a network environment in which a response generation system 100 and response generation process 200 may be practiced. Network 1002 (e.g. a private wide area network (WAN) or the Internet) includes a number of networked server computer systems 1004(1)-(N) that are accessible by client computer systems 1006(1)-(N), where N is the number of server computer systems connected to the network. Communication between client computer systems 1006(1)-(N) and server computer systems 1004(1)-(N) typically occurs over a network, such as a public switched telephone network over asynchronous digital subscriber line (ADSL) telephone lines or high-bandwidth trunks, for example communications channels providing T1 or OC3 service. Client computer systems 1006(1)-(N) typically access server computer systems 1004(1)-(N) through a service provider, such as an internet service provider (“ISP”) by executing application specific software, commonly referred to as a browser, on one of client computer systems 1006(1)-(N).

Client computer systems 1006(1)-(N) and/or server computer systems 1004(1)-(N) are specialized computer programmed to improve conventional computer systems to implement and utilize the response generation system 100 and response generation process 200. The type of computer system that can be specially programmed to implement and utilize the response generation system 100 and response generation process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the response generation system 100 and response generation process 200 can be implemented using code stored in a tangible, non-transient computer readable medium and executed by one or more processors. In at least one embodiment, the response generation system 100 and response generation process 200 can be implemented completely in hardware using, for example, logic circuits and other circuits including field programmable gate arrays.

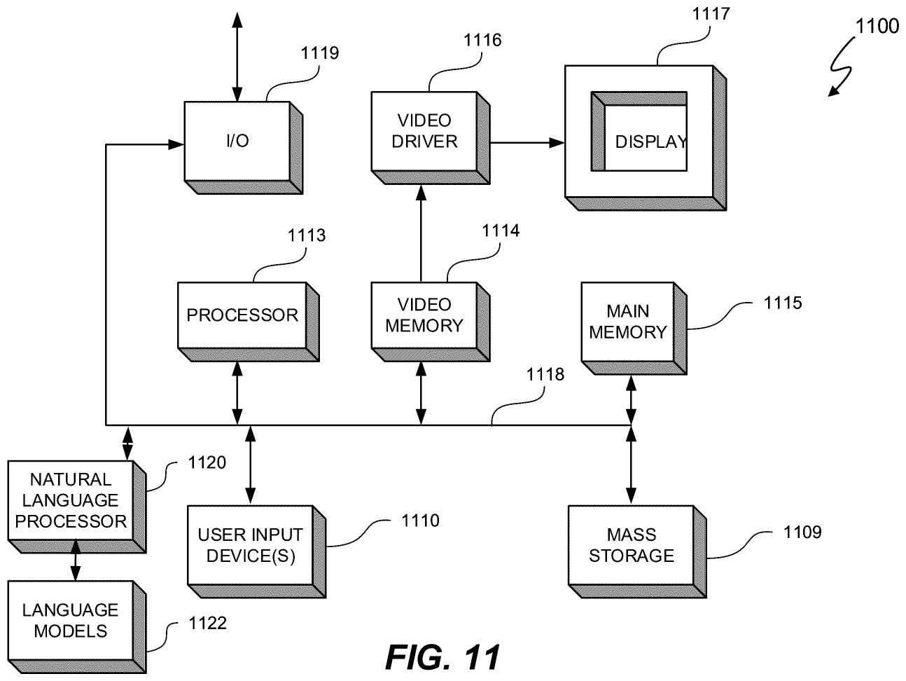

Embodiments of the response generation system 100 and response generation process 200 can be implemented on a computer system such as a special-purpose, special-programmed computer 1100 illustrated in FIG. 11. Input user device(s) 1110, such as a keyboard and/or mouse, are coupled to a bi-directional system bus 1118. The input user device(s) 1110 are for introducing user input to the computer system and communicating that user input to processor 1113. The computer system of FIG. 11 generally also includes a non-transitory video memory 1114, non-transitory main memory 1115, and non-transitory mass storage 1109, all coupled to bi-directional system bus 1118 along with input user device(s) 1110 and processor 1113. The mass storage 1109 may include both fixed and removable media, such as a hard drive, one or more CDs or DVDs, solid state memory including flash memory, and other available mass storage technology. Bus 1118 may contain, for example, 32 of 64 address lines for addressing video memory 1114 or main memory 1115. The system bus 1118 also includes, for example, an n-bit data bus for transferring DATA between and among the components, such as CPU 1109, main memory 1115, video memory 1114 and mass storage 1109, where “n” is, for example, 32 or 64. Alternatively, multiplex data/address lines may be used instead of separate data and address lines.

I/O device(s) 1119 may provide connections to peripheral devices, such as a printer, and may also provide a direct connection to a remote server computer systems via a telephone link or to the Internet via an ISP. I/O device(s) 1119 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 1109, into main memory 1115 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1113, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1115 is comprised of dynamic random access memory (DRAM). Video memory 1114 is a dual-ported video random access memory. One port of the video memory 1114 is coupled to video amplifier 1116. The video amplifier 1116 is used to drive the display 1117. Video amplifier 1116 is well known in the art and may be implemented by any suitable means. This circuitry converts pixel DATA stored in video memory 1114 to a raster signal suitable for use by display 1117. Display 1117 is a type of monitor suitable for displaying graphic images.

The computer system described above is for purposes of example only. The response generation system 100 and response generation process 200 may be implemented in any type of computer system or programming or processing environment. It is contemplated that the response generation system 100 and response generation process 200 might be run on a stand-alone computer system, such as the one described above. The response generation system 100 and response generation process 200 might also be run from a server computer systems system that can be accessed by a plurality of client computer systems interconnected over an intranet network. Finally, the response generation system 100 and response generation process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for guiding an Artificial Intelligence (AI) engine to generate a response by an AI avatar comprising:
executing code using one or more processors of a computer system to cause the computer system to perform operations comprising:
facilitating communication between a user and the AI avatar via an AI guidance and control system to receive user inputs;
receiving real-time inputs from a human representative associated with the AI avatar through a mobile application, wherein the mobile application is in communication with the AI guidance and control system;
generating a prompt by a prompt generator to guide the AI engine to enable dynamic interaction and continuous learning of the AI avatar to generate the response;
transferring the prompt to the AI engine to generate the response and provide the generated response to the AI avatar, wherein the AI engine is configured to:
ingest user inputs from the AI guidance and control system and real-time inputs from the human representative;
process and analyze the user inputs and real-time inputs using a natural language processing (NLP) algorithm to interpret the content;
update a knowledge base of the AI avatar based on the analyzed user inputs and real-time inputs;
processing the analyzed user inputs and real-time inputs multimodally using a multimodal processing engine on a cloud-based server, wherein the multimodal processing engine processes text, voice, and other input types from the user and the human representative; and
providing personalized responses to the user by the AI avatar through the AI guidance and control system, wherein the responses are based on the updated knowledge base.

2. The method of claim 1 further comprising:
interacting with the user through text-based interaction channels, including messaging platforms, web-based chat interfaces, or mobile applications.

3. The method of claim 1 further comprising:
interacting with the user through voice-based interaction channels, including voice assistants, smart speakers, or other audio input devices.

4. The method of claim 1 wherein, receiving real-time inputs from the human representative in various formats, including text, voice, and multimedia inputs through the mobile application.

5. The method of claim 1 further comprising
storing historical user interactions in the cloud-based server, and analyzing the interactions between the user and the AI avatar using machine learning algorithms to improve responses of the AI avatar.

6. The method of claim 1 wherein, notifying the human representative via an alert on the mobile application when new user interactions require the real-time inputs for the AI avatar.

7. The method of claim 1 wherein, processing feedback from the user through in the AI guidance and control system to refine the knowledge base and improve future interactions of the AI avatar.

8. The method of claim 1 wherein, prioritizing real-time inputs from the human representative over historical data when updating the knowledge base to ensure the responses of the AI avatar reflect most current information.

9. The method of claim 1 wherein, structuring the knowledge base hierarchically to allow certain types of real-time inputs of the human representative to override previously stored data in the knowledge base.

10. A system for guiding an Artificial Intelligence (AI) engine to generate a response by an AI avatar comprising:
one or more processors;
memory, operatively coupled to the one or more processors, that stored code that when executed causes the one or more processors to perform operations comprising:
executing codes using one or more processors of a computer system to cause the computer system to perform operations comprising:
facilitating communication between a user and the AI avatar via an AI guidance and control system to receive user inputs;
receiving real-time inputs from a human representative associated with the AI avatar through a mobile application, wherein the mobile application is in communication with the AI guidance and control system;
generating a prompt by a prompt generator to guide the AI engine to enable dynamic interaction and continuous learning of the AI avatar to generate the response;
transferring the prompt to the AI engine to generate the response and provide the generated response to the AI avatar, wherein the AI engine is configured to:
ingest user inputs from the AI guidance and control system and real-time inputs from the human representative;
process and analyze the user inputs and real-time inputs using a natural language processing (NLP) algorithm to interpret the content;
update a knowledge base of the AI avatar based on the analyzed user inputs and real-time inputs;
processing the analyzed user inputs and real-time inputs multimodally using a multimodal processing engine on a cloud-based server, wherein the multimodal processing engine processes text, voice, and other input types from the user and the human representative; and
providing personalized responses to the user by the AI avatar through the AI guidance and control system, wherein the responses are based on the updated knowledge base.

11. The system of claim 10 further comprising:
interacting with the user through text-based interaction channels, including messaging platforms, web-based chat interfaces, or mobile applications.

12. The system of claim 10 further comprising:
interacting with the user through voice-based interaction channels, including voice assistants, smart speakers, or other audio input devices.

13. The system of claim 10 wherein, receiving real-time inputs from the human representative in various formats, including text, voice, and multimedia inputs through the mobile application.

14. The system of claim 10 further comprising
storing historical user interactions in the cloud-based server, and analyzing the interactions between the user and the AI avatar using machine learning algorithms to improve responses of the AI avatar.

15. The system of claim 10 wherein, notifying the human representative via an alert on the mobile application when new user interactions require the real-time inputs for the AI avatar.

16. The system of claim 10 wherein, processing feedback from the user through in the AI guidance and control system to refine the knowledge base and improve future interactions of the AI avatar.

17. The system of claim 10 wherein, prioritizing real-time inputs from the human representative over historical data when updating the knowledge base to ensure the responses of the AI avatar reflect most current information.

18. The system of claim 10 wherein, structuring the knowledge base hierarchically to allow certain types of real-time inputs of the human representative to override previously stored data in the knowledge base.
